(19) United States
(12) Patent Application Publication
(10) Pub. No.: US 2013/0161558 A1
(43) Pub. Date: Jun. 27, 2013

(54) LITHIUM-TITANIUM COMPLEX OXIDE, AND BATTERY ELECTRODE AND LITHIUM ION SECONDARY BATTERY CONTAINING SAME

(71) Applicant: TAIYO YUDEN CO., LTD., Tokyo (JP)

(72) Inventors: Chie KAWAMURA, Takasaki-shi (JP); Masaki MOCHIGI, Takasaki-shi (JP); Daigo ITO, Takasaki-shi (JP); Akitoshi WAGAWA, Takasaki-shi (JP); Yoichiro OGATA, Takasaki-shi (JP); Toshiyuki OCHIAI, Takasaki-shi (JP); Toshimasa SUZUKI, Takasaki-shi (JP)

(73) Assignee: TAIYO YUDEN CO., LTD., Tokyo (JP)

(21) Appl. No.: 13/688,032

(22) Filed: Nov. 28, 2012

(30) Foreign Application Priority Data
Dec. 26, 2011 (JP) 2011-284288

(51) Int. Cl. H01M 4/485

(52) U.S. Cl. CPC H01M 4/485
USPC 252/182.1

(57) ABSTRACT

A lithium-titanium complex oxide in a particulate form whose main ingredient is Li₄Ti₅O₁₂ contains potassium (K), wherein (S_{SK}/S_{STi})/(Cₖ) is 12 or less and preferably (S_{SK}/S_{STi})−(S_{IK}/S_{ITi}) is 0.01 or less, where S_{SK} is the K2p peak area of potassium (K) and S_{STi} is the Ti2p peak area of titanium (Ti) based on X-ray photoelectron spectral measurement of the particle surface, Cₖ is the content ratio (percent by mass) of potassium (K), S_{IK} is the K2p peak area of potassium (K) and S_{ITi} is the Ti2p peak area of titanium (Ti) based on X-ray photoelectron spectral measurement in the interior of the particle. The lithium-titanium complex oxide is suitable for manufacture of high-capacity batteries.

### BACKGROUND

1. Field of the Invention

The present invention relates to a lithium ion secondary battery, an electrode thereof, and a lithium-titanium complex oxide titanate suitable as the material of such electrode.

2. Description of the Related Art

Lithium titanates having a spinel structure such as Li₄Ti₅O₁₂ undergo little volume change and are highly safe. Lithium ion secondary batteries using these lithium titanates for their negative electrode are beginning to be used in automotive and infrastructure applications. However, the market is demanding significant reduction of battery cost. Carbon materials are generally used to make negative electrodes and, although their safety is inferior to lithium titanates, carbon materials offer high capacity and are much cheaper than lithium titanates. Accordingly, it is important to maintain the high performance of lithium titanates and still increase the efficiency of their manufacturing process. The performances (electrochemical characteristics) required of lithium titanates include high capacity, high rate characteristics (high-speed charge/discharge) and long life.

Known methods to synthesize lithium titanates include the wet method and solid phase method. The wet method provides fine particles of high crystalline property and, among the various types of wet methods, the sol-gel method allows for uniform solution of those elements that are otherwise difficult to convert into solid solution or available only in trace amounts. However, the wet method as a whole presents many economic and environmental challenges because the materials used are expensive, processes are complex, and large amounts of effluent must be treated. The solid phase method is advantageous in terms of mass production because the materials used are less expensive and readily available and processes are simple. Accordingly, it is proposed to use the solid phase method by adding trace elements to obtain lithium titanate particles offering good characteristics.

Patent Literature 1 discloses a lithium titanate as an active material used for lithium secondary batteries demonstrating excellent charge/discharge characteristics, wherein such lithium titanate has a K₂O content of 0.10 to 0.25 percent by mass and P₂O₅ content of 0.10 to 0.50 percent by mass and is mainly constituted by Li₄Ti₅O₁₂. Patent Literature 2 discloses a lithium titanate containing sulfur and also describes the Li/Ti ratio. Patent Literature 3 discloses that, if unreacted Li component such as hydroxide, carbonate, or the like that are not taken into the lithium titanate is exposed at the surface and the pH value increases to over 11.2 as a result, the battery performance tends to drop. According to Patent Literature 3, because this unreacted Li component reacts with a non-aqueous electrolyte and generates carbon dioxide or hydrocarbon gas, and also because this secondary reaction causes an organic film to form on the surface of the active material and become a resistance component, the battery performance, especially high-temperature cycle performance and output performance, can be improved by reducing the unreacted Li component to a pH level of less than 11.2.

### BACKGROUND ART LITERATURES

[Patent Literature 1] Japanese Patent No. 4558229

[Patent Literature 2] Japanese Patent Laid-open No. 2011-113796

[Patent Literature 3] Japanese Patent Laid-open No. 2007-18883

### SUMMARY

When an electrode coating solution (electrode paste) is produced using a lithium-titanium complex oxide containing potassium (K), problems occur such as the viscosity changing depending on the lithium-titanium complex oxide used and viscosity or agglomerated state changing over time. In particular, it has been shown that the aforementioned problems occur easily when the potassium (K) concentration at the surface is high. It has also been shown that the aforementioned problems become prominent when the Li/Ti mol ratio is high.

In consideration of the above, the object of the present invention is to provide a lithium-titanium complex oxide that is suitable for manufacture of high-capacity batteries, can be manufactured using the solid phase method associated with low manufacturing cost, and offers preservation stability, as well as an electrode and lithium ion secondary battery using such lithium-titanium complex oxide.

Any discussion of problems and solutions involved in the related art has been included in this disclosure solely for the purposes of providing a context for the present invention, and should not be taken as an admission that any or all of the discussion were known at the time the invention was made.

The inventors of the present invention completed the invention described below.

According to the present invention, a lithium-titanium complex oxide in a particulate form whose main ingredient is Li₄Ti₅O₁₂ and which contains potassium (K) is provided, where (S_{SK}/S_{STi})/(Cₖ) is 12 or less. Here, S_{SK} is the K2p peak area of potassium (K) and S_{STi} is the Ti2p peak area of titanium (Ti) based on X-ray photoelectron spectral measurement of the particle surface, and Cₖ is the content ratio (percent by mass) of potassium (K).

Furthermore, preferably (S_{SK}/S_{STi})−(S_{IK}/S_{ITi}) is 0.01 or less. Here, S_{IK} is the K2p peak area of potassium (K) and S_{ITi} is the Ti2p peak area of titanium (Ti) based on X-ray photoelectron spectral measurement on the interior of the particle of the lithium-titanium complex oxide, and S_{SK} and S_{STi} are as explained above.

Or, preferably the lithium-titanium complex oxide contains 0.01 to 0.25 percent by mass of potassium (K), while the mol ratio of lithium to titanium, or Li/Ti, is 0.76 to 0.84 in another favorable embodiment, and the lithium-titanium complex oxide contains sulfur in another favorable embodiment.

According to the present invention, a battery electrode that contains the aforementioned lithium-titanium complex oxide as an active material is provided. This electrode may be a positive electrode or negative electrode. Furthermore, according to the present invention, a lithium ion secondary battery having such positive electrode or negative electrode is provided.

The lithium-titanium complex oxide proposed by the present invention contains potassium (K) and is suitable for manufacture of high-capacity lithium ion secondary batteries. Also, a paste containing this lithium-titanium complex oxide offers excellent stability over time because adsorption of CO₂ and water is suppressed due to a low abundance ratio of potassium at the material surface. In a favorable embodiment, potassium is contained in a relatively uniform manner in the depth direction of the lithium-titanium complex oxide, which prominently increases the battery capacity and improves paste stability over time as mentioned above. When adsorption of CO₂ and water is suppressed, as mentioned above, the stability over time of a paste containing this lithium-titanium complex oxide improves and a smooth electrode sheet can be produced continuously, which in turn improves the manufacturing efficiency and also prevents the electrolyte solution and electrode from reacting to each other when a lithium ion secondary battery is manufactured, thereby achieving the improved cycle characteristics of the battery as mentioned above.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic section view of a half cell.

FIG. 2 is a schematic section view of a full cell.

### DESCRIPTION OF THE SYMBOLS

1 Al lead

2 Thermo-compression bonding tape

3 Kapton tape

4 Aluminum foil

5, 15, 16 Electrode mixture

6 Metal Li plate

7 Ni mesh

8 Ni lead

9 Separator

10 Aluminum laminate

### DETAILED DESCRIPTION OF EMBODIMENTS

The ceramic material proposed by the present invention is mainly constituted by a lithium-titanium complex oxide of spinel structure expressed by Li₄Ti₅O₁₂, where this lithium-titanium complex oxide typically accounts for 90% or more, or preferably 95% or more, of the ceramic material proposed by the present invention. In this Specification, such ceramic material is referred to as “lithium-titanium complex oxide.”

According to the present invention, the lithium-titanium complex oxide is a particulate, where the particle may be in a powder form where very small particles are aggregated together, or an inorganic component contained in a paste into which a resin (binder) has been mixed, or a molding obtained by heat-treating such paste, for example.

Potassium is a required trace constituent that must be contained in the lithium-titanium complex oxide. The content of potassium (equivalent K atom content) is preferably 0.01 to 0.25 percent by mass, or more preferably 0.05 to 0.2 percent by mass, based on the mass of the lithium-titanium complex oxide being 100%. The lithium-titanium complex oxide may contain sulfur, where the content of sulfur (equivalent S atom content) is preferably 0.01 to 0.09 percent by mass. The lithium-titanium complex oxide may contain phosphorous, where the content of phosphorous (equivalent P atom content) is preferably 0.013 to 0.24 percent by mass, or more preferably 0.05 to 0.2 percent by mass. Presence of potassium allows a lithium-titanium complex oxide of higher initial discharge capacity to be obtained, where coexistence of phosphorous makes this effect more prominent. In a favorable embodiment of the present invention, the lithium-titanium complex oxide contains sulfur and consequently adsorption of carbon dioxide and water is more prominently suppressed and preservation stability of a paste, etc., containing the lithium-titanium complex oxide improves.

According to the present invention, the main crystalline system of the lithium-titanium complex oxide is a lithium titanate of spinel structure, which is expressed by the composition formula of Li₄Ti₅O₁₂ and can be confirmed by the presence of a specified X-ray diffraction peak. The lithium-titanium complex oxide may have intermediate phases such as TiO₂ and Li₂TiO₃ mixed in it, where these intermediate phases cause the charge/discharge capacity of the battery to drop. Lower abundance of Li₂TiO₃ is preferable because water and CO₂ will not be absorbed easily. Lower abundance of secondary phases and intermediate layers means the mol ratio of lithium to titanium (Li/Ti) in the lithium-titanium complex oxide is close to the stoichiometric composition, or 4/5 to be specific, and in this sense the aforementioned mol ratio is preferably 0.76 to 0.84.

Under the solid phase method, the lithium-titanium complex oxide is typically obtained by mixing and sintering a titanium compound, lithium compound, and trace constituents. For the source titanium, a titanium oxide is typically used. The particle size of the lithium-titanium complex oxide is affected by the particle size of titanium oxide. Accordingly, use of a fine titanium oxide tends to easily produce a fine lithium-titanium complex oxide. On the other hand, preferably the specific surface area of the titanium oxide is in a range of 8 to 30 m²/g in order to avoid cohesion, which in turn will require more energy for mixing. For the source lithium, a carbonate, acetate or hydroxide is typically used. If a lithium hydroxide is used, it may be a hydrate such as monohydrate or the like. For the source lithium, two or more of the foregoing may be combined. Preferably a source lithium is mixed while being crushed and made finer to a maximum particle size of 10 μm or less, or a source lithium having a small maximum particle size is used from the beginning, as it would lower the lithium-titanium complex oxide production temperature, which is favorable when manufacturing a fine lithium-titanium complex oxide. It should be noted that, since lithium may decrease as a result of partial volatilization, loss due to sticking to equipment walls, or for other reasons in the manufacturing process, it is preferable to use a greater amount of source lithium than the final target amount of Li.

It should be noted that, as mentioned above, Li may decrease as a result of volatilization, loss due to sticking to equipment walls, or for other reasons, during the manufacturing process. The ratio of source lithium and source titanium used as the materials should be determined by considering this decrease in Li. To get an idea on the level of decrease in Li, the results of examples explained later can be used as reference. These data can be used to easily determine the amount of source lithium to be added.

According to the present invention, the obtained lithium-titanium complex oxide may contain potassium of a specified ratio amount, and it may further contain sulfur or phosphorous. These elements can be added to the materials in the form of oxides of potassium, phosphorous and sulfur, respectively, or in the form of potassium, phosphorous and sulfur with other compounds (for example, compounds with lithium and titanium).

For the source potassium, a carbonate, hydrogen carbonate, or hydroxide etc is typically used.

For the source phosphorous, an ammonium phosphate, etc., can be used. By using a potassium dihydrogen phosphate, dipotassium hydrogenphosphate, tripotassium phosphate or other substance containing both potassium and phosphorous, the source potassium and source lithium can be satisfied by only one compound.

For the source sulfur, any alkali metal salt of sulfur, especially lithium sulfate or potassium sulfate, is typically used. Lithium sulfate and potassium sulfate can be used not only as a source sulfur, but also as a source lithium or source potassium.

The lithium-titanium complex oxide proposed by the present invention may contain only each of the elements mentioned above, or it may further contain, in addition to the foregoing elements, trace amounts of silicon, zirconium, niobium, calcium, sodium, etc.

According to the present invention, preferably little potassium is present at the surface of the lithium-titanium complex oxide particle. Presence of potassium at the particle surface can be measured using an X-ray photoelectron spectrum. To be specific, X-ray photoelectron spectral measurement is performed on the surface of the particle of the particulate lithium-titanium complex oxide to be measured, to obtain the K2p peak area of potassium (K) as S_{SK}. Similarly, X-ray photoelectron spectral measurement is performed on the particle surface to calculate the Ti2p peak area of titanium (Ti) as S_{STi}. The content ratio of potassium (K) in the lithium-titanium complex oxide is given as (Cₖ) (percent by mass). Equation (1) below using these values should yield a value of 12 or less:

(S_{SK}/S_{STi})/(C_{K}) Equation (1)

This shows that a lower abundance of potassium at the surface allows less water and CO₂ to be adsorbed and consequently the preservation stability of a paste, etc., containing this lithium-titanium complex oxide improves.

Preferably the potassium concentration is almost constant over a specified range from the surface of the lithium-titanium complex oxide. In other words, preferably the abundance of potassium at the surface of the particle of the lithium-titanium complex oxide is equivalent to the abundance of potassium on the interior of the particle. Presence of potassium in the particle can also be measured using an X-ray photoelectron spectrum. To be specific, X-ray photoelectron spectral measurement is performed on the interior of the particle of the particulate lithium-titanium complex oxide to be measured, to obtain the K2p peak area of potassium (K) as S_{IK}. Similarly, X-ray photoelectron spectral measurement is performed on the interior of the particle to calculate the Ti2p peak area of titanium (Ti) as S_{ITi}. Equation (2) below using these measured values as well as S_{IK} and S_{ITi} explained above should yield a value of 0.01 or less:

(S_{SK}/S_{STi})−(S_{IK}/S_{ITi}) Equation (2)

Here, measurement on the interior of the particle is performed by subjecting the lithium-titanium complex oxide particle to Ar ion sputtering under the same conditions that achieve sputtering to a depth of 40 nm in the case of a SiO₂ film, after which X-ray photoelectron spectral measurement is performed.

According to the present invention, required potassium is present evenly in the lithium-titanium complex oxide. Accordingly, a high-capacity battery is obtained and, because there is less potassium at the surface, amounts of water and CO₂ absorbed are suppressed. Preferably the specific surface area of the lithium-titanium complex oxide is 3 to 14 m²/g.

According to the present invention, a high-quality lithium-titanium complex oxide can be obtained using the solid phase method. Under the solid phase method, the aforementioned materials are weighed and then mixed and sintered. In the mixing process, simultaneously adding a crushing effect reduces the growth of lithium-titanium complex oxide particles because the thermal decomposition reaction temperature of lithium carbonate as described later decreases. The mixing process may be wet mixing or dry mixing. Wet mixing is a method whereby a dispersion medium such as water, ethanol or the like is used together with a ball mill, planetary ball mill, bead mill, wet jet mill, etc. Dry mixing is a method where a ball mill, planetary ball mill, bead mill, vertical type roller mill, jet mill or flow-type mixer, an air stream style grinder such as cyclone mill, or machines capable of applying compressive force or shearing force to achieve precision mixing or efficiently add mechano-chemical effect such as Nobilta (Hosokawa Micron) and Miralo (Nara Machinery), etc., or two or more of the foregoing combined, is/are used for mixing without using dispersion medium.

In the case of dry mixing, water or organic solvent can be used as a mixing auxiliary. For the organic solvent, alcohol, ketone, etc., can be used. Examples of the alcohol include methanol, ethanol, propanol, butanol, ethylene glycol, propylene glycol, diethylene glycol, triethylene glycol, dipropylene glycol, tripropylene glycol, glycerin, and the like, while examples of the ketone include acetone, diethyl ketone, methyl ethyl ketone, methyl isobutyl ketone, acetyl acetone, cyclohexanone, and the like. Any one of the foregoing or mixture of two or more can be added by a trace amount to increase the efficiency of mixing.

In the case of wet mixing, load in the drying process can be reduced by minimizing the use of the dispersion medium. If the amount of dispersion medium is too little, the slurry becomes highly viscous and may clog the piping or present other problems. Accordingly, preferably a small amount (approx. 5 percent by mass or less) of dispersion medium such as polyacrylate or the like is used, where desirably the solid content is adjusted to a range of 4.8 to 6.5 mol/L for Li material and 6 to 7.9 mol/L for titanium oxide at the time of mixing.

At the time of mixing, the order in which the dispersion medium (water, etc.), dispersant, Li material and titanium material are added does not affect the quality of the final product. For example, the dispersion medium, dispersant, Li material and titanium material can be added, in this order, under agitation using agitating blades. Or, the Li material and titanium material can be roughly mixed beforehand and then added in the last step, as it saves mixing time and increases efficiency.

Whichever mixing method is used, if a carbonate is used for the source Li, it is preferable to mix the ingredients until the weight loss due to CO₂ dissociation caused by breakdown of lithium carbonate no longer occurs based on heat analysis measurement of the material mixed powder at 700° C. or below. In this case, the measurement conditions for heat analysis are as follows: Use a platinum container of 5 mm in diameter, 5 mm in height and 0.1 mm in thickness, 15 mg of sample and Al₂O₃ as a standard sample; raise the temperature at a rate of 5° C./min up to 850° C.; and introduce, as an ambient gas, a gas mixture consisting of 80% nitrogen and 20% oxygen, by the flow rate recommended for the heat analyzer. Any measurement system can be used, such as Thermo Plus TG8120 by Rigaku or TG-DTA2000S by Mac Science and the like, as these machines achieve similar results. If breakdown of lithium carbonate does not end at 700° C. or below, mixing should be continued until the thermal breakdown temperature becomes 700° C. or below. It is deemed that the lower the ending temperature of thermal breakdown of lithium carbonate, the more uniformly the source titanium and lithium carbonate are mixed, which in turn allows for a lower setting of sintering temperature and reduces the growth of lithium-titanium complex oxide particles. In addition, by mixing the ingredients until the thermal breakdown temperature of lithium carbonate becomes 700° C. or below, mixing of the trace amounts of potassium compound, phosphorous compound, and niobium compound added will progress sufficiently.

For the sintering temperature after mixing, a typical condition is 700 to 1000° C., and a preferable condition is 700 to 900° C. The sintering time is preferably 12 hours or less, or more preferably 5 hours or less.

The amount of the lithium-titanium complex oxide of spinel structure expressed by Li₄Ti₅O₁₂, contained in the lithium-titanium complex oxide proposed by the present invention, can be obtained by powder X-ray diffraction measurement. Powder X-ray diffraction measurement was performed by powder XRD (Ultima IV by Rigaku, target Cu, acceleration voltage 40 kV, discharge current 40 mA, divergence slit width 1°, divergence longitudinal slit width 10 mm). The peak intensity ratio of each compound is expressed relative to the peak intensity on the Li₄Ti₅O₁₂ (111) plane (2θ=18.331) being 100. The value of each 2θ was taken from the JCPDS card.

The peak intensity ratio of the Li₄Ti₅O₁₂ (111) plane is calculated as follows:

Peak intensity ratio of Li₄Ti₅O₁₂ (111) plane=a/(a+b+c+d+e)×100

(a: Peak intensity of Li₄Ti₅O₁₂ (111) plane (2θ=18.331), b: Peak intensity of Li₂TiO₃ (−133) plane (2θ=48.583), c: Peak intensity of rutile TiO₂ (110) plane (2θ=27.447), d: Peak intensity of KTi₈O₁₆ (310) plane (2θ=27.610), e: Main peak intensity of a compound derived from other trace element

By adjusting the peak intensity ratio of the Li₄Ti₅O₁₂ (111) plane to 90% or greater, or preferably 95% or greater, the initial discharge capacity can be increased. Preferably the sintering temperature and sintering time are adjusted as deemed appropriate so that the specific surface area becomes 3 to 11 m²/g, and by adjusting the specific surface area to this range, the secondary battery will express high rate characteristics.

There is no limitation on the sintering ambience, and sintering can be performed in atmosphere, oxygen atmosphere, or inert gas atmosphere, under either atmospheric pressure or decompression. Sintering can also be performed multiple times. Sintered powder may be crushed/classified or re-sintered, as necessary. Although the solid phase method discussed above is advantageous in terms of cost among the manufacturing methods for lithium-titanium complex oxide, the sol-gel method or wet method using alkoxide can also be adopted.

One way to cause less potassium to be present at the surface of the lithium-titanium complex oxide, and roughly uniformly throughout the lithium-titanium complex oxide, is to crush the powder after the aforementioned sintering. Crushing can be implemented by the material mixing method described above. If water is used as a dispersant to perform wet crushing, the dispersant can be filtered or solid contents separated by sedimentation to remove the dispersant, in order to reduce the potassium concentration at the surface. The remaining amount of potassium can be controlled by means of controlling the ratio of remaining water in the cake. Crushing can also be performed after drying the cake.

Next, preferably heat treatment is performed again (annealing). Favorable annealing conditions include 100 to 600° C. for 1 minute to 3 hours. To be more specific, preferably annealing is performed by (A) keeping the maximum annealing temperature to 490° C. or below or (B) keeping the maximum annealing temperature to within 490 and 600° C. and also adjusting the ambient CO₂ to 10 ppm or less and water to 50° C. below the dew point in the subsequent cooling to room temperature.

Condition (A) above prevents a liquid phase with potassium and lithium from generating easily, while condition (B) above makes adsorption of CO₂ and water more difficult, thereby ensuring excellent stability over time of a paste containing the obtained lithium-titanium complex oxide.

Annealing can be performed under decompression or atmospheric pressure, or in an atmosphere containing oxygen or inert atmosphere, and if an organic substance is added during crushing, an atmosphere containing oxygen is suitable.

The lithium-titanium complex oxide proposed by the present invention can be used favorably as an active electrode material for lithium ion secondary batteries. It can be used for positive electrodes or negative electrodes. The configurations and manufacturing methods of electrodes containing the lithium-titanium complex oxides, their active material, and lithium ion secondary battery having such electrodes, can apply any prior technology as deemed appropriate.

Also in the examples explained later, an example of manufacturing a lithium ion secondary battery is presented. Typically a suspension agent containing the lithium-titanium complex oxide as an active material, conductive auxiliary, binder, and appropriate solvent is prepared and this suspension agent is applied to the metal piece of the current collector, etc., and dried, and then pressed to form an electrode.

For the conductive auxiliary, metal powder such as carbon material, aluminum powder or the like, or conductive ceramics such as TiO or the like can be used. Examples of the carbon material include acetylene black, carbon black, coke, carbon fiber, and graphite.

Examples of the binder include various resins, or specifically fluororesins etc, for example, polytetrafluoroethylene (PTFE), polyvinylidene difluoride (PVdF), fluororubber, styrene butadiene rubber, and the like.

Preferably the blending ratio of negative electrode active material, conductive agent, and binder is 80 to 98 percent by mass of negative electrode active material, 0 to 20 percent by mass of conductive agent, and 2 to 7 percent by mass of binder.

The current collector is preferably an aluminum foil or aluminum alloy foil of 20 μm or less in thickness.

When the lithium-titanium complex oxide material is used as a negative electrode active material, the material used for the positive electrode is not specifically limited and any known material can be used, where examples include lithium-manganese complex oxide, lithium-nickel complex oxide, lithium-cobalt complex oxide, lithium-nickel-cobalt complex oxide, lithium-manganese-nickel complex oxide, spinel lithium-manganese-nickel complex oxide, lithium-manganese-cobalt complex oxide, and lithium iron phosphate, etc.

For the conductive agent, binder, and current collector for the positive electrode, those materials mentioned above can be used. Preferably the blending ratio of positive electrode active material, conductive agent, and binder is 80 to 95 percent by mass of positive electrode active material, 3 to 20 percent by mass of conductive agent, and 2 to 7 percent by mass of binder.

From the positive/negative electrodes thus obtained, an electrolyte solution constituted by lithium salt, and an organic solvent or organic solid electrolyte or inorganic solid electrolyte, and a separator, etc., a lithium ion secondary battery can be constituted.

Examples of the lithium salt include lithium perchlorate (LiClO₄), lithium hexafluorophosphate (LiPF₆), lithium tetrafluoroborate (LiBF₄), lithium hexafluoroarsenate (LiAsF₆), lithium trifluorometanesulfonate (LiCF₃SO₃), lithium bis-trifluoromethyl sulfonyl imide [LiN(CF₃SO₂)₂], and the like. One type of lithium salt may be used, or two or more types may be combined. Examples of the organic solvent include propylene carbonate (PC), ethylene carbonate (EC), vinylene carbonate and other cyclic carbonates; diethyl carbonate (DEC), dimethyl carbonate (DMC), methyl ethyl carbonate (MEC) and other chained carbonates; tetrahydrofuran (THF), 2-methyl tetrahydrofuran (2MeTHF), dioxolane (DOX) and other cyclic ethers; dimethoxy ethane (DME), dietoethan (DEE) and other chained ethers; y-butyrolactone (GBL); acetonitrile (AN); and sulfolane (SL), etc., either used alone or combined into a mixed solvent.

For the organic solid electrolyte, for example, polyethylene derivative, polyethylene oxide derivative or polymer compound containing it, or polypropylene oxide derivative or polymer compound containing it, is suitable. Among the inorganic solid electrolytes, Li nitride, halogenated Li, and Li oxyate are well-known. In particular, Li₄SiO₄, Li₄SiO₄—LiI—LiOH, xLi₃PO₄-(1-x)Li₄SiO₄, Li₂SiS₃, Li₃PO₄—Li₂S—SiS₂, phosphorus sulfide compound, etc., are effective.

For the separator, a polyethylene microporous membrane is used. The separator is installed between the two electrodes in a manner not allowing the positive electrode and negative electrode to contact each other.

### EXAMPLES

The present invention is explained more specifically using examples. It should be noted, however, that the present invention is not limited to the embodiments described in these examples. First, how the samples obtained by the examples/comparative examples were analyzed and evaluated is explained.

(Element Analysis)

Samples of lithium-titanium complex oxide were put through pressurized acid decomposition, after which atomic absorption spectrometry or ICP atomic emission spectroscopy measurement was used to perform quantitative analysis of the contained elements. The abundance ratios (percent by mass) of potassium, phosphorous and sulfur were calculated based on the weight of the lithium-titanium complex oxide being 100%. For lithium, the value quantified by ICP atomic emission spectroscopy was used. For titanium, the value obtained as the difference between the amount of ignition loss at up to 900° C. and mass of all elements quantified by the element analysis was used, and the Li/Ti mol ratio was calculated accordingly.

(Battery Evaluation—Half Cell)

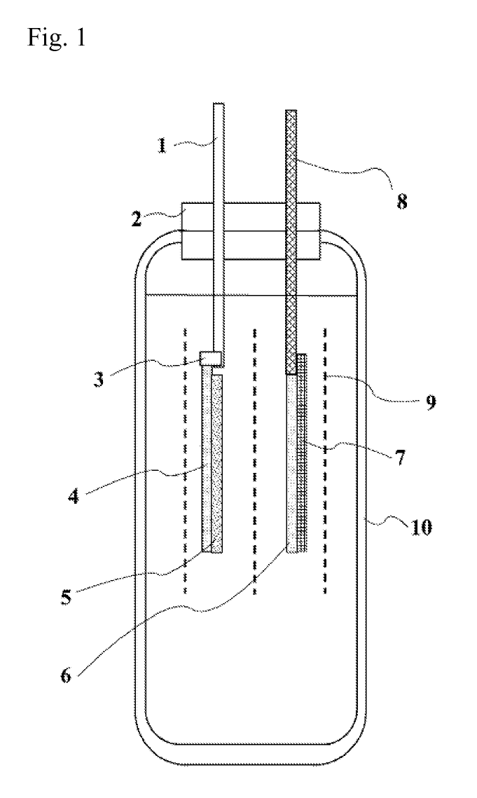

FIG. 1 is a schematic section view of a half cell. With this cell, lithium metal is used for the counter electrode, so the potential of the electrode shown is nobler than that of the counter electrode. Accordingly, the directions of charge/discharge are the opposite of those applicable when lithium-titanium complex oxide is used for the negative electrode.

To avoid confusion, the direction in which lithium ions are inserted into the lithium-titanium complex oxide electrode is called “charge,” while the direction in which lithium ions dissociate from the electrode is called “discharge.” An electrode mixture was prepared using lithium-titanium complex oxide as an active material. Ninety parts by weight of the obtained lithium-titanium complex oxide as an active material, 5 parts by weight of acetylene black as a conductive auxiliary, and 5 parts by weight of fluororesin as a binder, were mixed using n-methyl-2-pyrrolidon as a solvent.

This electrode mixture 5 was applied to an aluminum foil 4 to a coating weight of 0.003 g/cm² using the doctor blade method. The coated foil was vacuum-dried at 130° C., and then roll-pressed. Thereafter, an area of 10 cm² was stamped out from the pressed foil to obtain a working electrode of a battery. For the counter electrode, a metal Li plate 6 attached to a Ni mesh 7 was used. For the electrolyte solution, ethylene carbonate and diethyl carbonate were mixed at a volume ratio of 1:2, and then 1 mol/L of LiPF₆ was dissolved into the obtained solvent. For a separator 9, a porous cellulose membrane was used. Also, as illustrated, Al leads 1, 8 were fixed using a thermo-compression bonding tape 2, and the Al lead 1 was fixed to the working electrode using a Kapton tape 3. An aluminum laminate cell 10 was thus prepared. This battery was used to measure the initial discharge capacity. The battery was charged to 1.0 V at a constant current of 0.105 mA/cm² (0.2 C) in current density, and then discharged to 3.0 V, with the cycle repeated three times and the discharge capacity in the third cycle used as the value of initial discharge capacity. Preferably the initial discharge capacity is 155 mAh/g or more. Next, the rate characteristics were measured. The battery was charged to 1.0 V at a constant current of 0.525 mA/cm² in current density, and then discharged to 3.0 V, with the cycle repeated twice and similar measurements performed by increasing the current density in steps to 1.05 mA/cm², 1.575 mA/cm², 2.626 mA/cm², 5.25 mA/cm², and 8 mA/cm². The ratio of the discharge capacity in the second cycle at a current density of 8 mA/cm², and the value of initial discharge capacity, was indicated as the rate characteristics (%). Preferably the rate characteristics are 60% or more.

(Battery Evaluation—Full Cell)

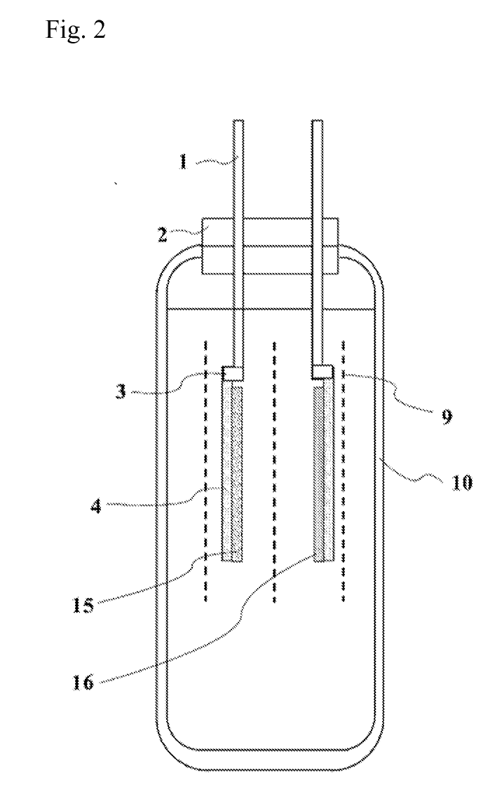

FIG. 2 is a schematic section view of a full cell. A negative electrode mixture 15 was prepared using as an active material the lithium-titanium complex oxide obtained in Example 1 mentioned later. To be specific, a negative electrode using the obtained lithium-titanium complex oxide as its active material was manufactured in the same manner as the working electrode of the half cell mentioned above. A positive electrode mixture 16 was obtained by mixing 90 parts by weight of lithium cobaltate as an active material (D50%=10 μm), 5 parts by weight of acetylene black as a conductive auxiliary, and 5 parts by weight of fluororesin as a binder, together with n-methyl-2-pyrrolidone as a solvent. This electrode mixture was applied to an aluminum foil to a coating weight of 0.0042 g/cm² using the doctor blade method. The coated foil was vacuum-dried at 130° C., and then roll-pressed to obtain a positive electrode. The electrolyte solution and separator 9 conformed to those of the half cell mentioned above. An aluminum laminate cell was thus prepared. This battery was used to measure the initial discharge capacity. The battery was charged to 2.8 V at a constant current of 0.105 mA/cm² (0.2 C) in current density, and then discharged to 1.5 V, with the cycle repeated three times and the discharge capacity in the third cycle used as the value of initial discharge capacity. Next, the rate characteristics were measured. The battery was charged to 1.5 V at a constant current of 0.525 mA/cm² in current density, and then discharged to 2.8 V, with the cycle repeated twice and similar measurements performed by increasing the current density in steps to 1.05 mA/cm², 1.575 mA/cm², 2.625 mA/cm², 5.25 mA/cm², and 8 mA/cm². The ratio of the discharge capacity in the second cycle at a current density of 8 mA/cm², and the value of initial discharge capacity, was indicated as the rate characteristics (%).

(XPS Measurement)

Preparation of sample: 25 mg of powder sample was put in a 6.5-mm diameter aluminum container for thermal analysis and pressed with a single-axis pressurization hydraulic press at a pressure of 30 kgf/cm² for 1 minute, after which the pressed powder was let stand overnight in an XPS measurement apparatus and then deaerated in vacuum.

Measurement: The Quantera SXM by Ulvac-Phi was used. A monochromatized Al Kα ray (25 W, 15 kV) was used as the excitation X-ray, with the analysis diameter set to 100 μm and charge neutralization performed using electrons and Ar ions. The sample was set horizontally and narrow scan measurement (pass energy 112 eV, step size 0.1 eV, detector angle 45 degrees) was performed on Ti2p and K2p to analyze the surface. For the depth analysis, the sample was set horizontally and the lithium-titanium complex oxide was subjected to Ar ion sputtering under the same conditions that would achieve sputtering to a depth of 40 nm for a SiO₂ film using a standard sample from Ulvac-Phi (25 nm, SIO₂/Si) at a speed of 1.18 nm/min (area of 2 mm×2 mm), and spectral measurement of K2p and Ti2p was performed at a pass energy of 112 eV, step size of 0.1 eV and detector angle of 45 degrees. When the KRATOS AXIS-HS by Shimadzu was used (analysis diameter was set in a range of 500 to 1000 μm during measurement) with a Mg Kα ray and monochromatized Al Kα ray at a SiO₂-film sputtering speed of 0.75 nm/min, similar measured results were obtained. This confirms that measured data was not dependent on the apparatus.

(Measurement of CO₂ Amount)

A GCMS equipped with a thermal decomposition apparatus (Double-shot Pyrolyzer PY2020iD by Frontier Laboratories) (GC unit: Agilent 6890, MS unit: Auto Mass AMII) was used. The measurement sample was introduced into the thermal decomposition unit and let stand for 3 minutes under a He flow. Thereafter, measurement was performed at the rate of temperature rise of 20° C./min, temperature range of 60° C. to 800° C., carrier gas of He, split ratio of approx. 1/10, column inner diameter and length of 0.25 mm and 8.7 m (empty column), respectively, GC oven temperature of 250° C., inlet temperature of 300° C., detector of MS, and sample amount of 3 mg. The CO₂ (m/z=44) area was obtained from the start to end of measurement. Following the measurement of the measurement sample, 1 mg of calcium oxalate (CaC₂O₄—H₂O) was measured in the same manner and the measured results obtained were used to correct the CO₂ area to mass. The measurement sample was measured three times and an average of three measurements was used as the amount of CO₂ generation. Preferably the amount of CO₂ generation is less than 3000 ppm by weight in order to ensure paste stability, etc.

(Paste Stability over Time)

An electrode mixture paste containing a lithium-titanium complex oxide was evaluated for stability over time. For the electrode mixture paste, the aforementioned paste prepared for the production of a half cell was used. Using a rheometer (AR-2000) by TA Instruments, the target paste was measured for viscosity (Pa-s) at a sheer speed of 1 (1/s) immediately after its production and after having been let stand for 5 hours, and the difference was obtained. The paste is considered stable and will not affect the production efficiency if its viscosity difference is 40 or less in absolute value.

### Example 1

The ratio of input Li/Ti atoms was set to 0.805. Lithium carbonate (commercial high-purity reagent of 99% in purity) was used as a source Li, and a high-purity titanium oxide of 99.9% in purity and 10±1 m²/g in specific surface area was used. For the pure water used as a dispersant, an amount that would give a concentration of solid contents of 52 percent by mass was added, while potassium hydroxide was added as a source potassium and ammonium dihydrogen phosphate, as a source phosphorous, to obtain a slurry.

The obtained slurry was mixed under agitation using a bead mill. Thereafter, the dispersant was removed using a spray dryer and the remainder was heat-treated in atmosphere at 820° C. for 3 hours. This was followed by crushing using pure water and a bead mill, and the filter-pressed cake was dried, and dry-cracked, and then heat-treated at 500° C. for 1 hour in an ambience of a mixed gas of 20% 0₂ and 80% N₂ not containing CO₂ (less than 1 ppm) (dew point—70° C.), after which the cake was cooled to room temperature without being exposed to atmosphere.

The lithium-titanium complex oxide obtained in Example 1 was also given a full-cell evaluation in addition to the half-cell evaluation described above. The half-cell evaluation was the same as shown in Table 1, and the full-cell evaluation results were exactly the same as the half-cell evaluation results. The value calculated by Equation (2) above was 0.0008.

### Example 2

The ratio of input Li/Ti atoms was set to 0.805. Lithium carbonate (commercial high-purity reagent of 99% in purity) was used as a source Li, and a high-purity titanium oxide of 99.9% in purity and 10±1 m²/g in specific surface area was used. Potassium hydroxide was added as a source potassium and ammonium dihydrogen phosphate, as a source phosphorous. ZrO₂ balls of 10 in diameter were used to dry-mix the ingredients for 2 hours in a planetary ball mill, after which the mixture was heat-treated in atmosphere at 820° C. for 3 hours. This was followed by crushing using pure water and a bead mill, and the filter-pressed cake was dried, and dry-cracked, and then heat-treated at 400° C. for 1 hour in an atmosphere of a mixed gas of 20% 0₂ and 80% N₂ not containing CO₂ (less than 1 ppm) (dew point—70° C.), after which the cake was cooled to room temperature without being exposed to atmosphere. The value calculated by Equation (2) above was 0.0010.

### Example 3

A lithium-titanium complex oxide was obtained in the same manner as in Example 2, except that the amount of the source potassium was changed and annealing temperature was also changed to 600° C. The value calculated by Equation (2) above was 0.0066.

### Example 4

A lithium-titanium complex oxide was obtained in the same manner as in Example 2, except that the amount of the source potassium was changed and annealing temperature was also changed to 500° C. The value calculated by Equation (2) above was 0.0023.

### Example 5

A lithium-titanium complex oxide was obtained in the same manner as in Example 2, except that the amount of the source potassium was changed and annealing temperature was also changed to 600° C. The value calculated by Equation (2) above was 0.0100.

### Comparative Example 1

A lithium-titanium complex oxide was obtained in the same manner as in Example 1, except that potassium hydroxide was not added.

### Comparative Example 2

A lithium-titanium complex oxide was obtained in the same manner as in Example 3, except that annealing was performed in the form of heat-treating at 600° C. for 1 hour under a flow of air of 25° C. and relative humidity of 90%. The value calculated by Equation (2) above was 0.0220.

### Comparative Example 3

A lithium-titanium complex oxide was obtained in the same manner as in Comparative Example 2, except that the amount of the source potassium was changed.

### Example 6

A lithium-titanium complex oxide was obtained in the same manner as in Example 1, except that the ratio of input Li/Ti atoms was changed to 0.764. The value calculated by Equation (2) above was 0.0007.

### Example 7

A lithium-titanium complex oxide was obtained in the same manner as in Example 2, except that the amount of the source potassium was changed and the ratio of input Li/Ti atoms was also changed to 0.764. The value calculated by Equation (2) above was 0.0050.

### Example 8

A lithium-titanium complex oxide was obtained in the same manner as in Example 5, except that the ratio of input Li/Ti atoms was changed to 0.764. The value calculated by Equation (2) above was 0.0090.

### Example 9

A lithium-titanium complex oxide was obtained in the same manner as in Example 1, except that the ratio of input Li/Ti atoms was changed to 0.845. The value calculated by Equation (2) above was 0.0007.

### Example 10

A lithium-titanium complex oxide was obtained in the same manner as in Example 7, except that the ratio of input Li/Ti atoms was changed to 0.845. The value calculated by Equation (2) above was 0.0020.

### Example 11

A lithium-titanium complex oxide was obtained in the same manner as in Example 5, except that the ratio of input Li/Ti atoms was changed to 0.845. The value calculated by Equation (2) above was 0.0020.

### Examples 12, 13

A lithium-titanium complex oxide was obtained in the same manner as in Example 7, except that the ratio of input Li/Ti atoms was changed to 0.805 and lithium sulfate was added further as a material. The amount of sulfur is shown in Table 1. The value calculated by Equation (2) above was 0.0070 (Example 12) and 0.0060 (Example 13).

### Examples 14 to 17

A lithium-titanium complex oxide was obtained in the same manner as in Example 7, except that the amount of phosphorous was changed according to Table 1. The value calculated by Equation (2) above was 0.0070 (Example 14), 0.0080 (Example 15), 0.0080 (Example 16), and 0.0080 (Example 17).

The compositions and measured results/evaluation results of obtained lithium-titanium complex oxides are summarized in Table 1.

In Table 1, the “Change in paste viscosity” field represents the difference between the viscosity (Pa-s) of the paste immediately after its production and that of the paste after having been let stand for 5 hours, at a sheer speed of 1 (1/s).

TABLE 1

| | Li/Ti | | | | | | | | |
|---|---|---|---|---|---|---|---|---|---|
| | Element | | | | | | Amount of | | |
| | ratio | K | P | | Value per | S | CO₂ | Change in | |
| | (measured | Percent | Percent | (K2p peak area S_{SK})/ | Equation | Percent | generation | paste | Capacity |
| | value) | by mass | by mass | (Ti2p peak area S_{STi}) | (1) | by mass | wt ppm | viscosity | mAh/g |
| Example 1 | 0.80 | 0.01 | 0.10 | 0.001 | 10.0 | 0.00 | 1100 | −25 | 162 |
| Example 2 | 0.80 | 0.05 | 0.10 | 0.006 | 12.0 | 0.00 | 1180 | −29 | 167 |
| Example 3 | 0.80 | 0.20 | 0.10 | 0.011 | 5.5 | 0.00 | 1270 | 33 | 167 |
| Example 4 | 0.80 | 0.20 | 0.10 | 0.003 | 1.5 | 0.00 | 1000 | −20 | 168 |
| Example 5 | 0.80 | 0.25 | 0.10 | 0.020 | 8.0 | 0.00 | 2050 | −30 | 169 |
| Comparative example 1 | 0.80 | 0.00 | 0.10 | — | — | 0.00 | 1000 | −31 | 151 |
| Comparative example 2 | 0.80 | 0.20 | 0.10 | 0.029 | 14.5 | 0.00 | 3700 | −75 | 165 |
| Comparative example 3 | 0.80 | 0.14 | 0.10 | 0.019 | 13.6 | 0.00 | 3100 | −55 | 152 |
| Example 6 | 0.76 | 0.01 | 0.10 | 0.001 | 10.0 | 0.00 | 1080 | −20 | 159 |
| Example 7 | 0.76 | 0.12 | 0.10 | 0.011 | 9.2 | 0.00 | 1190 | − [symbol] 7 | 161 |
| Example 8 | 0.76 | 0.25 | 0.10 | 0.019 | 7.6 | 0.00 | 1400 | 10 | 163 |
| Example 9 | 0.84 | 0.01 | 0.10 | 0.001 | 10.0 | 0.00 | 2100 | −25 | 160 |
| Example 10 | 0.84 | 0.12 | 0.10 | 0.012 | 10.0 | 0.00 | 2300 | −30 | 161 |
| Example 11 | 0.84 | 0.25 | 0.10 | 0.018 | 7.2 | 0.00 | 2800 | 36 | 164 |
| Example 12 | 0.80 | 0.12 | 0.10 | 0.011 | 9.2 | 0.01 | [symbol] 90 | − [symbol] 9 | 166 |
| Example 13 | 0.80 | 0.12 | 0.10 | 0.010 | 8.3 | 0.09 | [symbol] 70 | 28 | 165 |
| Example 14 | 0.80 | 0.12 | 0.01 | 0.011 | 9.2 | 0.00 | 1400 | −35 | 159 |
| Example 15 | 0.80 | 0.12 | 0.05 | 0.012 | 10.0 | 0.00 | 1240 | −20 | 167 |
| Example 16 | 0.80 | 0.12 | 0.15 | 0.013 | 10.8 | 0.00 | 1390 | 27 | 168 |
| Example 17 | 0.80 | 0.12 | 0.23 | 0.012 | 10.0 | 0.00 | 1600 | −28 | 163 |

[symbol]

indicates data missing or illegible when filed

The above results indicate that an electrode paste containing a lithium-titanium complex oxide conforming to the present invention would offer excellent stability over time and that an electrode made from such paste would have a high capacity.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2011-284288, filed Dec. 26, 2011, the disclosure of which, including the claims, is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A lithium-titanium complex oxide in a particulate form whose main ingredient is Li₄Ti₅O₁₂ and which contains potassium (K), wherein
(S_{SK}/S_{STi})/(Cₖ) is 12 or less, where S_{SK} is a K2p peak area of potassium (K) and S_{STi} is a Ti2p peak area of titanium (Ti) based on X-ray photoelectron spectral measurement of the particle surface, and Cₖ is a content ratio (percent by mass) of potassium (K).

2. A lithium-titanium complex oxide according to claim 1, wherein (S_{SK}/S_{STi})−(S_{IK}/S_{ITi}) is 0.01 or less, where S_{IK} is a K2p peak area of potassium (K) and Sₘ is a Ti2p peak area of titanium (Ti) based on X-ray photoelectron spectral measurement on an interior of the particle, and S_{SK} and S_{STi} are defined above.

3. A lithium-titanium complex oxide according to claim 1, containing 0.01 to 0.25 percent by mass of potassium (K).

4. A lithium-titanium complex oxide according to claim 1, wherein a mol ratio of lithium to titanium, or Li/Ti, is 0.76 to 0.84.

5. A lithium-titanium complex oxide according to claim 1, further containing sulfur.

6. A positive electrode for a battery containing the lithium-titanium complex oxide according to claim 1 as a positive electrode active material.

7. A negative electrode for a battery containing the lithium-titanium complex oxide according to claim 1 as a negative electrode active material.

8. A lithium ion secondary battery having a positive electrode containing a lithium-titanium complex oxide in a particulate form whose main ingredient is Li₄Ti₅O₁₂ and which contains potassium (K), wherein (S_{SK}/S_{STi})/(Cₖ) is 12 or less, or a negative electrode containing a lithium-titanium complex oxide in a particulate form whose main ingredient is Li₄Ti₅O₁₂ and which contains potassium (K), wherein (S_{SK}/S_{STi})/(Cₖ) is 12 or less, where S_{SK} is a K2p peak area of potassium (K) and S_{STi} is a Ti2p peak area of titanium (Ti) based on X-ray photoelectron spectral measurement of the particle surface, and Cₖ is a content ratio (percent by mass) of potassium (K).

9. A lithium-titanium complex oxide according to claim 2, containing 0.01 to 0.25 percent by mass of potassium (K).

10. A lithium-titanium complex oxide according to claim 2, wherein a mol ratio of lithium to titanium, or Li/Ti, is 0.76 to 0.84.

11. A lithium-titanium complex oxide according to claim 3, wherein a mol ratio of lithium to titanium, or Li/Ti, is 0.76 to 0.84.

12. A lithium-titanium complex oxide according to claim 2, further containing sulfur.

13. A lithium-titanium complex oxide according to claim 3, further containing sulfur.

14. A lithium-titanium complex oxide according to claim 4, further containing sulfur.

15. A positive electrode for a battery containing the lithium-titanium complex oxide according to claim 2 as a positive electrode active material.

16. A positive electrode for a battery containing the lithium-titanium complex oxide according to claim 3 as a positive electrode active material.

17. A positive electrode for a battery containing the lithium-titanium complex oxide according to claim 4 as a positive electrode active material.

18. A negative electrode for a battery containing the lithium-titanium complex oxide according to claim 2 as a negative electrode active material.

19. A negative electrode for a battery containing the lithium-titanium complex oxide according to claim 3 as a negative electrode active material.

20. A negative electrode for a battery containing the lithium-titanium complex oxide according to claim 4 as a negative electrode active material.
